(19) United States
(12) Patent Application Publication
(10) Pub. No.: US 2017/0335804 A1
(43) Pub. Date: Nov. 23, 2017

(54) EXHAUST GAS HEAT TRANSFER UNIT

(71) Applicant: Benteler Automobiltechnik GmbH, Paderborn (DE)

(72) Inventor: Sebastian MUELLER, Willebadessen-Peckelsheim (DE)

(21) Appl. No.: 15/598,642

(22) Filed: May 18, 2017

(30) Foreign Application Priority Data
May 19, 2016 (DE) 10 2016 109 247.9

(51) Int. Cl. F02M 26/29; F01N 13/08; F01N 5/02; F01N 13/18

(52) U.S. Cl. CPC F02M 26/29; F01N 13/1861; F01N 13/08; F01N 5/02; F01N 2470/06; F01N 2470/28

(57) ABSTRACT

An exhaust gas heat transfer unit is disclosed having a heat exchanger including a bypass duct, an inflow diffuser with an exhaust gas inlet, and an outflow diffuser with an exhaust gas outlet. The heat exchanger and the bypass duct are assigned a control apparatus which diverts the exhaust gas flow through the heat exchanger and/or the bypass duct.

### CROSS REFERENCE TO RELATED APPLICATIONS

The present application claims priority to German Application Number 10 2016 109 247.9 filed May 19, 2016, the disclosure of which is hereby incorporated by reference herein in its entirety.

### BACKGROUND OF THE INVENTION

### 1. Field of the Invention

The present invention generally relates to an exhaust gas heat transfer unit and, more specifically, to a switched exhaust gas recirculation cooler (EGR cooler).

### 2. Description of the Related Art

Exhaust gas heat transfer units are used in motor vehicles for cooling the exhaust gases. That is, an exhaust gas cooler in the exhaust gas recirculation system (EGR) serves to reduce the exhaust gas temperature and thus reducing the nitrogen oxide and particle emissions. A part of the exhaust gas is branched off downstream of the internal combustion engine and is subsequently conducted through an exhaust gas heat transfer unit. The cooled exhaust gas is then mixed with the fresh air drawn in by the internal combustion engine and is supplied to the internal combustion engine again.

Moreover, as a result of the cooled exhaust gas mass that is additionally recirculated into the combustion chamber, the thermal mass increases independently of stoichiometry conditions causing the combustion temperature falls. As a result of the reduced combustion temperature, the formation of nitrogen oxides during the combustion is reduced. Modern internal combustion engines, in particular diesel engines, almost always utilize cooled, recirculated. exhaust gases aside from in the cold-start phase, because the thermal mass in the combustion chamber can thereby be further increased in relation to a non-cooled exhaust gas recirculation system. This will allow compliance with the ever increasingly stringent emissions limit values for nitrogen oxides.

In the cold-start phase of an internal combustion engine, the exhaust gas recirculation system is often utilized for a faster warm-up of the engine. The hot exhaust gas is conducted, without being cooled, via the exhaust gas recirculation system into the combustion chamber of the engine. Hence, the engine warms up more quickly. The recirculation of the exhaust gas is normally realized here via a non-cooled tube, which is either integrated in the exhaust gas cooler or attached externally to the heat exchanger.

A modern exhaust gas recirculation system must consequently often be able to implement two operating modes:

a bypass mode in which, in the cold-start phase, a recirculation of non-cooled exhaust gas at the highest possible temperature is performed for the purposes of warming up the internal combustion engine. This way, the engine reaches its operating temperature more quickly and can thus be operated with the least possible emissions and greatest possible efficiency; and,

a heat exchanger mode in which, when the engine is at operating temperature, a recirculation of exhaust gas at the lowest possible temperature is performed for the purposes of preventing or reducing nitrogen oxide and particle emissions.

An example of an exhaust gas heat transfer unit is disclosed in DE 102 03 003 B4. A heat exchanger is integrated with a bypass duct in a housing. The heat exchanger itself is composed of a tube bundle of exhaust gas tubes, around which the coolant of the coolant circuit of an internal combustion engine flows. The heat of the exhaust gases thus passes via the coolant into the coolant circuit of the internal combustion engine and thus also into the heating circuit, in which a heating body through which coolant flows is arranged. Through the heating of the coolant circuit by the exhaust gas heat, it is also possible to realize faster heating of the vehicle interior compartment. This exhaust gas heat transfer unit thus functions as an additional heater in the warm-up phase. If heating of the coolant circuit is not desired, the exhaust gas flow is conducted through a bypass duct which is thermally insulated with respect to the exhaust-gas tubes and the coolant. The exhaust gas flow passing through the bypass duct thus releases practically no heat to the coolant. The diversion of the exhaust-gas flow through the exhaust-gas tubes around which the coolant flows, or through the insulated bypass duct, is realized by means of an exhaust gas valve which is arranged either in the exhaust gas inflow region or in the exhaust gas outflow region. The exhaust gas valve has a control means, for example a flap, which is actuated by means of an actuating drive and which diverts the exhaust gas flow through the heat exchanger or through the bypass duct.

Furthermore, the switching of the two operating modes is realized using the flap, which is situated in the inflow housing upstream of the heat exchanger and the bypass tube. The merging of the exhaust gas downstream of the heat exchanger or the bypass is then realized in the outflow housing, the so-called outflow diffuser. This takes place in uncontrolled fashion, such that, in the bypass mode, backflows into the exhaust-gas heat exchanger can occur. As a result, the hot exhaust gas is undesirably cooled, and the fast warm-up of the internal combustion engine is slowed.

An example of an inflow diffuser or a manifold box is disclosed in DE 201 21 112 U1. The manifold box includes at least one stiffening element produced in one piece with the wall of the manifold box has in an interior space thereof. The at least one stiffening element extends in a flow direction and it is intended not to influence the flow resistance. The stiffening element performs a purely mechanical function in the inlet region of the exhaust gas heat exchanger.

An example of a three-pass heat exchanger is disclosed in EP 2 025 913 B1. The three-pass heat exchanger includes a bypass mode having an outlet head which comprises a distribution chamber for distributing the exhaust gas arriving from a first gas circulation region to a second gas circulation region.

The problem of exhaust gas turbulence in the outflow diffuser and the backflow of exhaust gas into the heat exchanger can also be observed in the case of the known proposals. To alleviate this, presently used outflow diffusers are of relatively long form, which is however disadvantageous with regard to the structural space requirement.

### SUMMARY OF THE INVENTION

It is therefore an object of the present invention to improve an exhaust gas heat transfer unit and, more specifically, to improve an exhaust gas recirculation cooler (EGR cooler) in terms of its efficiency and in terms of structural space.

An exhaust-gas heat transfer unit according to an embodiment of the present invention has a heat exchanger and a bypass duct and an inflow diffuser with an exhaust-gas inlet and an outflow diffuser with an exhaust-gas outlet. The heat exchanger and the bypass duct are assigned a control means in the form of a bypass flap within the inflow diffuser. The latter is pivotable and diverts the exhaust gas flow through the heat exchanger and/or the bypass duct as required.

The heat exchanger may preferably be in the form of a plate-type heat exchanger or in the form of a tube bundle heat exchanger.

It is a further object of the present invention to have an outlet diffuser comprising at least one guide element which separates the exhaust gas flow from the heat exchanger and the exhaust gas flow from the bypass duct as far as into the region of the outlet. In this way, the backflow of exhaust gas into the heat exchanger and turbulence in the outflow diffuser are prevented.

The guide element is configured so as to separate the exhaust gas flow from the heat exchanger and the exhaust-gas flow from the bypass duct as far as into the region of the outlet, meaning that the extent is implemented, with regard to length and configuration, such that an exhaust gas transfer flow is prevented, or the exhaust gas passing from the bypass duct is prevented from flowing back to the heat exchanger. The guide element extends at least over the major part of the length of the outflow diffuser. The guide element may in this case end shortly upstream of the outlet or may extend as far as into the outlet.

It is a further object of the invention to provide the guide element being formed by a guide metal sheet. This is arranged in the outflow diffuser.

A further object of the invention is to have one or more guide elements formed by a separate duct. The merging of the two ducts takes place outside the heat exchanger in the region of the outlet of the outflow diffuser, preferably directly upstream of the outlet or in particular in the outlet. In this context, it is possible for the guide elements, or two merged ducts, to form the outflow diffuser.

Through the controlled merging of the exhaust gas by means of a guide element, preferably by means of a guide metal sheet or by means of two separate ducts which are then merged for the first time outside the heat exchanger, an undesired backflow of exhaust gas into the heat exchanger is prevented. In this way, the undesired cooling of the exhaust gas in the bypass mode is avoided, and a fast warm-up of the internal combustion engine can be ensured by means of optimum bypassing of an exhaust-gas recirculation system.

The outflow diffuser and the guide element may be formed materially integrally as a cast part. The components may be made of austenitic or ferritic high-grade steel materials.

It is also possible to have an assembled embodiment of the outflow diffuser composed of sheet-metal components, and more specifically, of high-grade steel.

In the case of an exhaust gas heat transfer unit which is particularly advantageous in practice, the heat exchanger and the bypass duct are arranged in a common housing.

Furthermore, the heat exchanger and the bypass duct may be arranged in separate housings.

The one or more guide elements prevent a backflow of exhaust gas into the heat exchanger and turbulence in the outflow diffuser. The one or more guide elements in the outflow diffuser allow the outflow diffuser to be made considerably more compact and shorter in terms of structural space. Thus, despite a reduction in volume of the outflow diffuser, the desired flow and/or diversion of the exhaust gas flow can be realized. It is therefore possible to realize a relatively small exhaust gas heat transfer unit with high power.

### BRIEF DESCRIPTION OF THE DRAWINGS

The invention will be described in more detail below on the basis of exemplary embodiments illustrated in the drawings, in which:

FIG. 1 is a side schematic view of an exhaust gas heat transfer unit according to one embodiment;

FIG. 2 is a side schematic view of an exhaust gas heat transfer unit according to a second embodiment;

FIG. 3 is a perspective view of an outflow diffuser of an exhaust gas heat transfer unit;

FIG. 4 is a side sectional view through the outflow diffuser illustrated in FIG. 3; and,

FIG. 5 is a perspective view of the outflow diffuser from the direction of the heat exchanger and the bypass duct.

In the figures, the same reference signs are used for identical or similar components even if a repeated description is omitted for reasons of simplicity.

### DETAILED DESCRIPTION OF SOME EMBODIMENTS

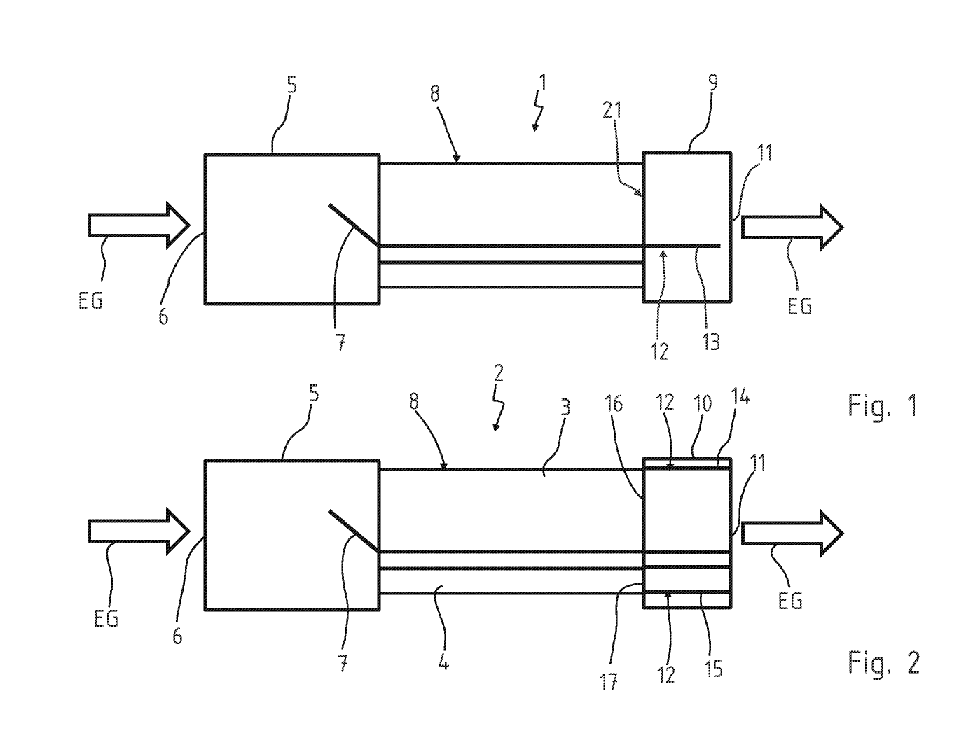

FIG. 1 illustrates an exhaust gas heat transfer unit 1 in form of a switched exhaust gas recirculation cooler (EGR cooler), and FIG. 2 illustrates an alternative embodiment of an exhaust gas heat transfer unit designated by reference numeral 2.

Each exhaust gas heat transfer unit 1, 2 includes a heat exchanger 3 functioning as an exhaust gas cooler, and a bypass duct 4. An inflow diffuser 5 is arranged upstream of the heat exchanger 3 and the bypass duct 4 in an exhaust gas flow direction shown by arrow EG in FIGS. 1 and 2. The exhaust gas EG enters the exhaust gas heat transfer unit 1, 2 via an exhaust gas inlet 6 in the inflow diffuser 5. In the inflow diffuser 5, the heat exchanger 3 and the bypass duct 4 are assigned a controller such as, but not limited to, a bypass flap 7. The bypass flap 7 functions as a switch for conducting the exhaust gas flow either through the heat exchanger 3 for cooling purposes or through the bypass duct 4 if no cooling of the exhaust gas EG is required. The bypass flap 7 closes the respective path through which the flow does not pass through.

The heat exchanger 3 and the bypass duct 4 are arranged in a common housing 8. The exhaust gas EG exits the exhaust gas heat transfer unit 1 or 2 via an outflow diffuser 9 positioned downstream of the heat exchanger 3 and the bypass duct 4 in a flow direction. The outflow diffuser 9 has an exhaust gas outlet 11 via which the exhaust gas is conducted out of the outflow diffuser 9 and is circulated to the intake air duct of the intake tract of the exhaust gas recirculation system.

In the exhaust gas heat transfer unit 1, a guide element 12 in the form of a guide metal sheet 13 is arranged in the outflow diffuser 9. The guide element 12 extends from the heat exchanger 3 and the bypass duct 4 as far as into the region of the exhaust-gas outlet 11. Here, the guide element 12 is configured so as to separate the exhaust-gas flow from the heat exchanger 3 and the exhaust-gas flow from the bypass duct 4 as far as into the region of the exhaust-gas outlet 11.

There are two guide elements 12 in form of separate ducts 14, 15 provided in the outflow diffuser 10 of the exhaust gas heat transfer unit 2. The first duct 14 is connected to the exhaust gas outflow side 16 of the heat exchanger 3. The second duct 15 communicates with the outlet 17 of the bypass duct 4. The two ducts 14, 15 run in the outflow diffuser 10 in the direction of the exhaust gas outlet 11 and separate the exhaust gas flow from the heat exchanger 3 and the exhaust gas flow from the bypass duct 4 as far as into the region of the exhaust gas outlet 11. The two ducts 14, 15 are merged at that point and the exhaust gas EG is conducted onward. It is contemplated for the two ducts 14, 15 to form the outflow diffuser 10, such that a separate diffuser housing is not required.

Moreover, both the outflow diffuser 9 in the first embodiment and the outflow diffuser 10 in the second embodiment together with the integrated guide elements 12 in the form of a guide metal sheet 13 or of ducts 14, 15 may be formed materially integrally as a cast part or as a multi-part sheet-metal component.

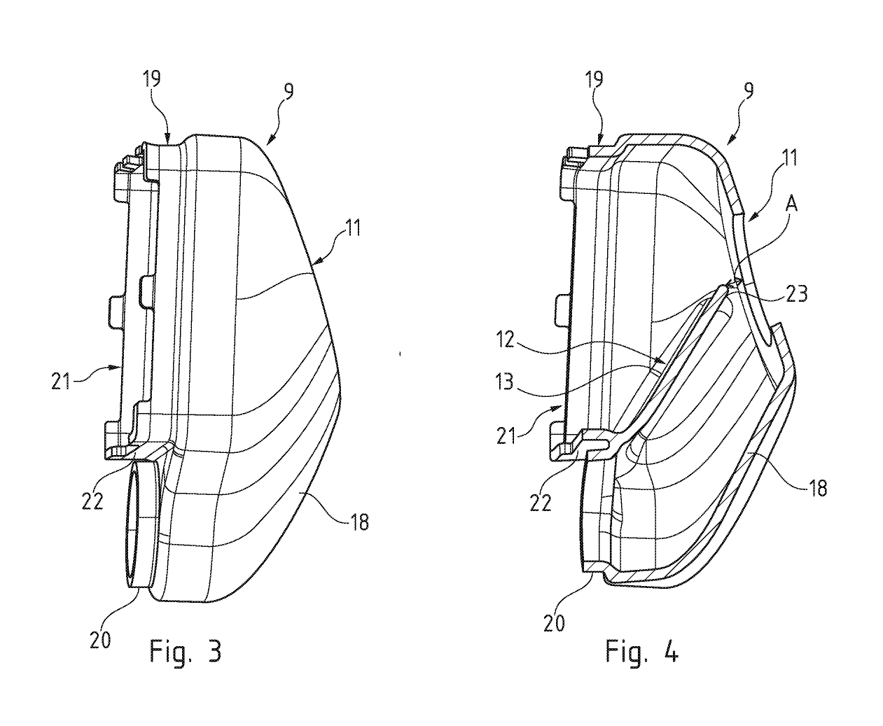

Referring to FIGS. 3 to 5, the outflow diffuser 9 shown FIG. 1 is illustrated. The outflow diffuser 9 is composed of high-grade cast steel and forms a cap-shaped diffuser housing 18. The diffuser housing 18 has an attachment section 19 of substantially rectangular configuration for coupling to the exhaust gas outflow side 16 of the heat exchanger 3.

Moreover, a connection port 20 is provided for attaching to the bypass duct 4. Depending on the operation of an exhaust gas heat transfer unit 1, exhaust gas EG flows from the heat exchanger 3 via the attachment section 19 into the outflow diffuser 9, or alternatively, via the connection port 20 from the bypass duct 4 into the outflow diffuser 9. From the outflow diffuser 9, the exhaust gas EG is discharged through the exhaust gas outlet 11 and conducted to downstream system components.

The guide element 12 in the form of the guide metal sheet 13 is formed in the outflow diffuser 9. The guide metal sheet 13 is a materially integral constituent part of the outflow diffuser 9. The guide metal sheet 13 extends from the inflow side 21 of the outflow diffuser 9, proceeding from the lower transverse web 22 of the attachment section 19, in the direction of the exhaust gas outlet 11, and ends in the region of the exhaust gas outlet 11. By means of the guide element 12 or the guide metal sheet 13, the exhaust gas flow from the heat exchanger 3 and the exhaust gas flow from the bypass duct 4 are separated as far as into the region of the exhaust gas outlet 11. It can be seen that the guide metal sheet 13 ends a short distance upstream of the exhaust-gas outlet 11. The distance A of the end 23 of the guide metal sheet 13 from the exhaust gas outlet 11 amounts to less than half of the diameter D of the exhaust gas outlet 11.

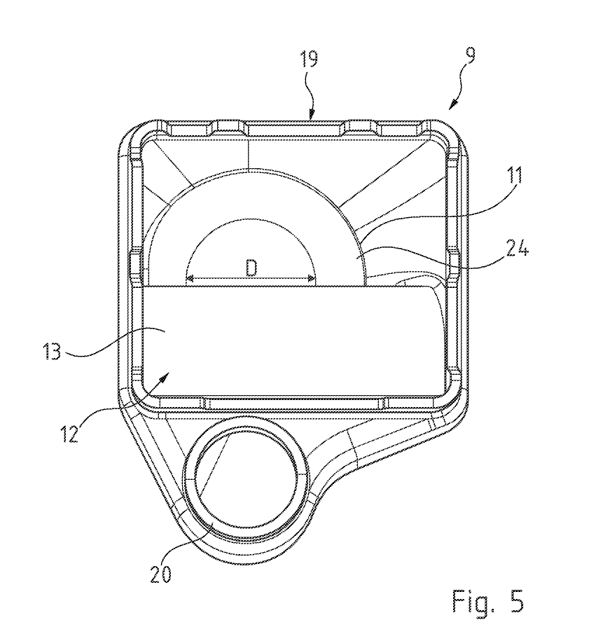

Referring more specifically to FIG. 5, the opening 24 of the exhaust gas outlet 11 has a substantially circular configuration. The guide metal sheet 13 extends inward in the outflow diffuser 9 over the width thereof and runs obliquely in the direction of the center of the opening 24 of the exhaust gas outlet 11.

The guide element 12 or the guide metal sheet 13, like the separate ducts 14, 15, prevent exhaust gas EG passing from the bypass duct 4 from flowing over or flowing back to the heat exchanger 3. The undesired or disadvantageous cooling of exhaust gas in the bypass mode is avoided, and thus a fast warm-up of the internal combustion engine is ensured by means of the optimized exhaust gas guidance in the outflow diffuser 9 of an exhaust gas heat transfer unit 1 or 2.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1. An exhaust gas heat transfer unit, comprising:
a heat exchanger having a bypass duct;
an inflow diffuser with an exhaust gas inlet;
an outflow diffuser with an exhaust gas outlet;
the heat exchanger and the bypass duct being assigned a control means which diverts the exhaust gas flow through the heat exchanger or the bypass duct;
wherein the outflow diffuser comprises at least one guide element which separates the exhaust gas flow from the heat exchanger and the exhaust gas flow from the bypass duct as far as into the region of the exhaust gas outlet.

2. The exhaust gas heat transfer unit of claim 1, wherein the at least one guide element is a guide metal sheet.

3. The exhaust gas heat transfer unit of claim 1, further comprising a plurality of guide elements each formed by a duct.

4. The exhaust gas heat transfer unit of claim 3, wherein two ducts form the outflow diffuser.

5. The exhaust gas heat transfer unit of claim 1, wherein the outflow diffuser and the guide element are formed materially integrally as a cast part.

6. The exhaust gas heat transfer unit of claim 1, wherein the outflow diffuser is in the form of a multi-part sheet-metal component.

7. The exhaust gas heat transfer unit of claim 1, further comprising a common housing, and wherein the heat exchanger and the bypass duct are arranged in the common housing.

8. The exhaust gas heat transfer unit of claim 1, wherein the heat exchanger and the bypass duct are arranged in separate housings.

9. The exhaust gas heat transfer unit of claim 1, wherein in particular switched exhaust gas recirculation cooler (EGR cooler).
